(19) United States
(12) Patent Application Publication
(10) Pub. No.: US 2019/0100146 A1
(43) Pub. Date: Apr. 4, 2019

(54) THREE-DIMENSIONAL DRIVING IMAGE REMINDER DEVICE

(71) Applicant: Hua-chuang Automobile Information Technical Center Co., Ltd., New Taipei City (TW)

(72) Inventor: Le-Hung Chen, New Taipei City (TW)

(21) Appl. No.: 15/722,365

(22) Filed: Oct. 2, 2017

(51) Int. Cl. B60R 1/00; B60K 35/00; B60Q 1/00; G03B 37/04; G01C 21/36; G06F 17/30

(52) U.S. Cl. CPC B60R 1/002; B60K 35/00; B60Q 1/0023; G03B 37/04; B60R 2300/8093; G06F 17/30244; B60K 2350/2017; B60R 2300/303; G01C 21/365

(57) ABSTRACT

A three-dimensional driving image reminder device includes a lens group, a three-dimensional image synthesis module, an image processing module, and a display module. The lens group includes a plurality of lenses, respectively photographing a plurality of external images around a vehicle. The three-dimensional image synthesis module receives the external images and synthesizes a three-dimensional panoramic projection image. The image processing module receives the three-dimensional panoramic projection image. The image processing module includes an obstacle recognition unit and a labeling unit. The obstacle recognition unit detects an obstacle in the three-dimensional panoramic projection image. The labeling unit sets a recognition label corresponding to a position of the obstacle to form a three-dimensional label image. The image processing module selectively outputs the three-dimensional label image. The display module receives and displays the three-dimensional label image.

### BACKGROUND

### Technical Field

The present invention relates to a reminder device, and more particularly to a three-dimensional driving image reminder device.

### Related Art

For a long time, most traffic accidents that occur during the travel of vehicles are caused by blind spots in vision that are caused by vehicle body structures (for example, A-pillars, B-pillars or C-pillars or panels at other positions). For example, when a driver steers a vehicle, an A-pillar of the vehicle easily blocks the sight of a pedestrian, a vehicle or a traffic sign in front to cause a traffic accident. A B-pillar easily blocks the sight of a moving object on a side of the vehicle, and as a result, when the driver steers the vehicle or changes lanes, the vehicle easily collides with a nearby vehicle.

However, currently, in a commercially available solution, a camera is disposed around a vehicle to photograph a surrounding picture of the vehicle, and the surrounding picture is displayed on a screen. However, the picture photographed by the camera is usually deformed, making it impossible for a driver to accurately distinguish the shape and size of an object or an obstacle outside the vehicle and a distance between the object or obstacle and the vehicle. In addition, when seeing a picture displayed on a screen, the driver cannot determine, instantly and accurately, whether an obstacle exists in the picture and determine a position of the obstacle. As a result, the driver cannot instantly react (hit the brake) correspondingly, which affects the driving safety.

### SUMMARY

In view of the foregoing problem, in an embodiment, a three-dimensional driving image reminder device is provided, including a lens group, a three-dimensional image synthesis module, an image processing module, and a display module. The lens group includes a plurality of lenses, respectively disposed on different positions around a vehicle, and respectively photographing a plurality of external images around the vehicle and outputting the external images. The three-dimensional image synthesis module is electrically connected to the lens group. The three-dimensional image synthesis module receives the external images, synthesizes the external images into a three-dimensional panoramic projection image, and outputs the three-dimensional panoramic projection image. The image processing module is electrically connected to the three-dimensional image synthesis module and receives the three-dimensional panoramic projection image. The image processing module includes an obstacle recognition unit and a labeling unit. The obstacle recognition unit detects an obstacle in the three-dimensional panoramic projection image. The labeling unit sets a recognition label corresponding to a position of the obstacle to form a three-dimensional label image. The image processing module selectively outputs the three-dimensional label image. The display module is disposed in the vehicle and is electrically connected to the image processing module. The display module receives and displays the three-dimensional label image.

In an embodiment, the recognition label may be a pattern, a symbol or a text.

In an embodiment, the obstacle recognition unit may further detect a distance between the obstacle and the vehicle, and the labeling unit further sets different recognition labels corresponding to different distances.

In an embodiment, the three-dimensional driving image reminder device may include a ranging module, electrically connected to the image processing module. The ranging module outputs a proximity signal according to the approach of the obstacle. The image processing module may output the three-dimensional label image corresponding to the proximity signal.

In an embodiment, the three-dimensional driving image reminder device may further include a GPS module, electrically connected to the image processing module. The GPS module is disposed at the vehicle and detects and outputs vehicle position information. The image processing module receives and selectively outputs the three-dimensional label image corresponding to the vehicle position information.

In an embodiment, the obstacle recognition unit further detects a distance between the obstacle and the vehicle. The labeling unit sets the recognition label when the distance is less than a threshold value.

In an embodiment, the image processing module may output the three-dimensional label image corresponding to a turn signal.

In an embodiment, the three-dimensional driving image reminder device may further include an alert module. The alert module sends an alert message corresponding to an output of the three-dimensional label image.

In an embodiment, the image processing module may include an image retrieval unit. The image retrieval unit receives the three-dimensional label image and retrieves a part of the three-dimensional label image to generate a partial label image. The partial label image includes the obstacle and the recognition label, and the image processing module selectively outputs the three-dimensional label image or the partial label image to the display module. The alert module sends the alert message corresponding to an output of the three-dimensional label image or the partial label image.

In an embodiment, the alert module may be a buzzer, a voice module or an alert lamp.

Therefore, by means of image processing and synthesis, the three-dimensional driving image reminder device in the embodiments of the present invention first establishes a three-dimensional panoramic projection image, then detects a position of an obstacle in the three-dimensional panoramic projection image, and correspondingly sets a recognition label, to output a three-dimensional label image to a display module for display, and an alert module correspondingly sends an alert message. Therefore, a displayed three-dimensional label image provides 3D perception to realistically present the surrounding environment of a vehicle, so as to enable a driver to easily and intuitively recognize a height difference of a nearby object and a distance from the nearby object. Furthermore, the alert message may warn a driver about a potential danger nearby, and the driver can instantly know the position of the obstacle and a distance between the obstacle and the vehicle according to the recognition label, so that the driver can instantly react correspondingly, thereby effectively improving the driving safety.

### BRIEF DESCRIPTION OF THE DRAWINGS

The present invention will become more fully understood from the detailed description given herein below for illustration only, and thus are not limitative of the present invention, and wherein:

FIG. 1 is a perspective view of a configuration of a lens group according to an embodiment of the present invention.

FIG. 2 is a device block diagram of a three-dimensional driving image reminder device according to an embodiment of the present invention.

FIG. 3 is a block diagram of a three-dimensional driving image reminder device according to another embodiment of the present invention.

FIG. 4 is a schematic diagram of a projection of a three-dimensional driving image reminder device according to an embodiment of the present invention.

FIG. 5 is a schematic diagram of a display of a three-dimensional label image according to an embodiment of the present invention.

FIG. 6 is a schematic diagram of a display of a partial label image according to an embodiment of the present invention.

### DETAILED DESCRIPTION

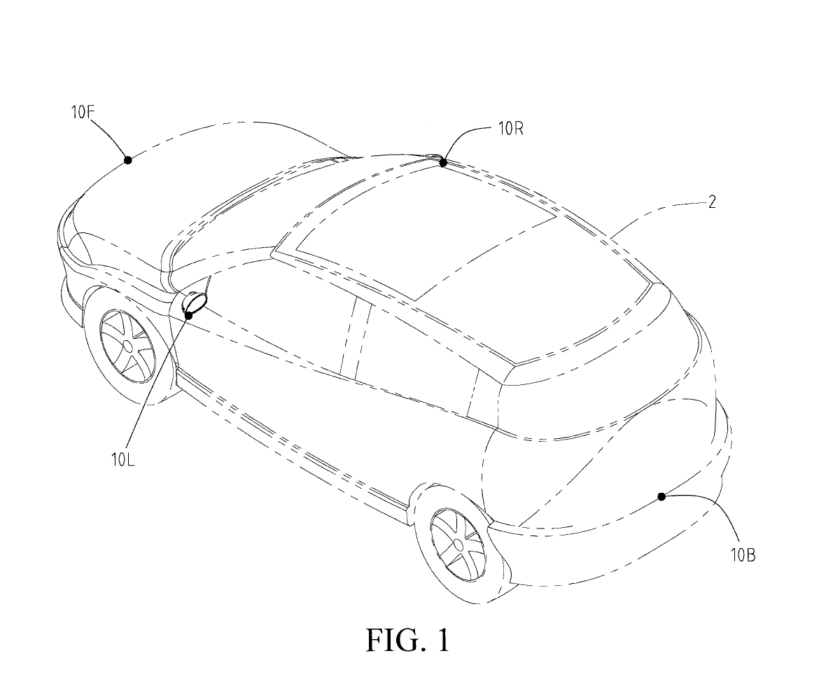

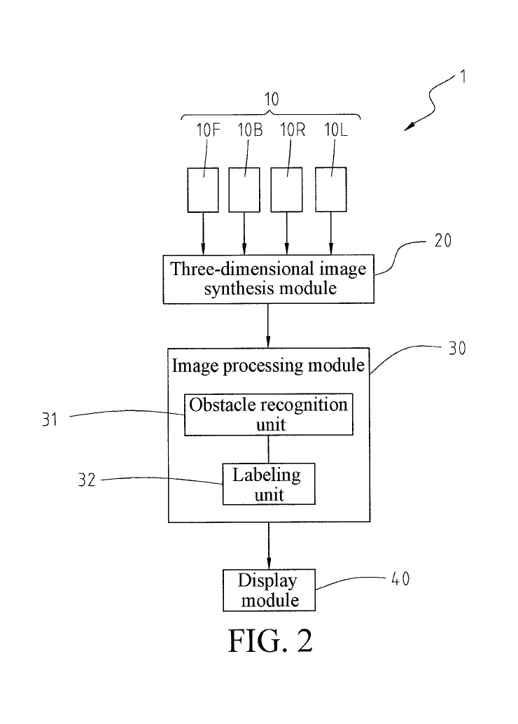

FIG. 1 is a perspective view of a configuration of a lens group according to an embodiment of the present invention. FIG. 2 is a device block diagram of a three-dimensional driving image reminder device according to an embodiment of the present invention. As shown in FIG. 2, in an embodiment, the three-dimensional driving image reminder device 1 includes a lens group 10, a three-dimensional image synthesis module 20, an image processing module 30, and a display module 40.

The lens group 10 includes a plurality of lenses, respectively disposed on different positions around a vehicle 2, and the lenses respectively photographing a plurality of external images around the vehicle 2 and outputting the external images. As shown in FIG. 1, in an embodiment, the lens group 10 includes a front-view lens 10F, a rear-view lens 10B, a left-view lens 10L, and a right-view lens 10R. The front-view lens 10F is mounted in the front of the vehicle 2. For example, the front-view lens 10F may be disposed on the front plate or the grille in the front, so as to photograph a vehicle-body front-side image I_{F}. The rear-view lens 10B is mounted in the rear of the vehicle 2. For example, the rear-view lens 10B may be disposed on a trunk cover, to photograph a vehicle-body rear-side image I_{B}. The left-view lens 10L and the right-view lens 10R are respectively mounted on a left side and a right side of the vehicle 2. For example, the left-view lens 10L is mounted on a left side-view mirror to photograph a vehicle-body left-side image I_{L}, and the right-view lens 10R may be mounted on a right side-view mirror to photograph a vehicle-body right-side image I_{R}. In fact, the quantity and angles of the lenses may all be adjusted according to an actual requirement. The foregoing description is only an example, but is not intended to constitute any limitation.

In addition, in some embodiments, the front-view lens 10F, the rear-view lens 10B, the left-view lens 10L, and the right-view lens 10R may be specifically wide-angle lenses or fisheye lenses. The vehicle-body front-side image I_{F}, the vehicle-body rear-side image I_{B}, the vehicle-body left-side image I_{L}, and the vehicle-body right-side image I_{R} at least partially overlap each other. In other words, the vehicle-body front-side image I_{F}, the vehicle-body rear-side image I_{B}, the vehicle-body left-side image I_{L}, and the vehicle-body right-side image I_{R} may all partially overlap each other without any gap, so as to obtain a complete image around the vehicle 2. The lens group 10 outputs the vehicle-body front-side image I_{F}, the vehicle-body rear-side image I_{B}, the vehicle-body left-side image I_{L}, and the vehicle-body right-side image I_{R} (that is, the plurality of external images).

The three-dimensional image synthesis module 20 is electrically connected to the lens group 10, and the three-dimensional image synthesis module 20 receives the external images, synthesizes the external images into a three-dimensional panoramic projection image Iₛᵤᵣᵣ, and outputs the three-dimensional panoramic projection image Iₛᵤᵣᵣ. In an embodiment, the three-dimensional image synthesis module 20 may be specifically implemented by using a microcomputer, a processor or a dedicated chip. The three-dimensional image synthesis module 20 may be mounted on the vehicle 2. As shown in FIG. 2, in an embodiment, the three-dimensional image synthesis module 20 is electrically connected to the front-view lens 10F, the rear-view lens 10B, the left-view lens 10L, and the right-view lens 10R. The three-dimensional image synthesis module 20 receives and may first combine the vehicle-body front-side image I_{F}, the vehicle-body rear-side image I_{B}, the vehicle-body left-side image I_{L}, and the vehicle-body right-side image I_{R} into a planar panoramic image, then synthesizes the planar panoramic image into the three-dimensional panoramic projection image Iₛᵤᵣᵣ, by using a back projection manner, and outputs the three-dimensional panoramic projection image Iₛᵤᵣᵣ.

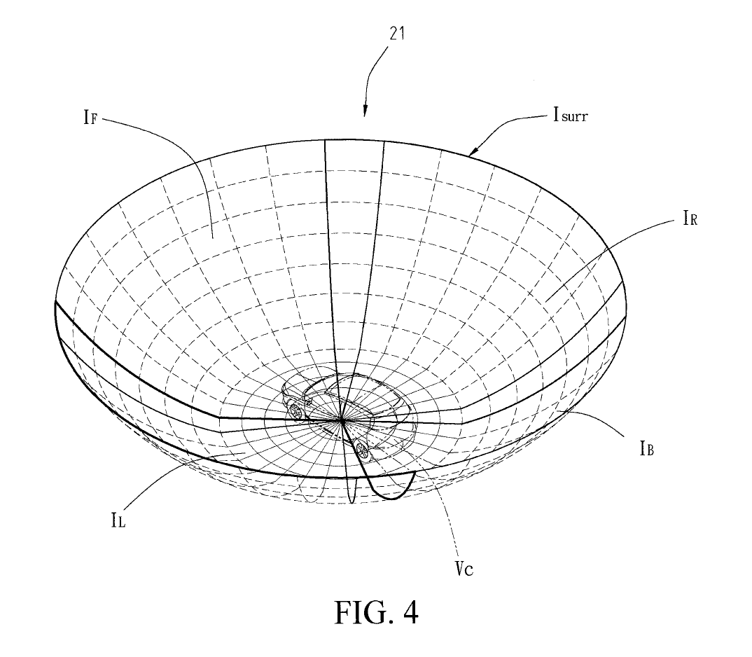

Alternatively, as shown in FIG. 4, in an embodiment, the three-dimensional image synthesis module 20 projects the vehicle-body front-side image I_{F}, the vehicle-body rear-side image I_{B}, the vehicle-body left-side image I_{L}, and the vehicle-body right-side image I_{R} onto a 3D panoramic model 21 (a bowl-shaped model here) to synthesize the three-dimensional panoramic projection image Iₛᵤᵣᵣ. Edges of the projections of the vehicle-body front-side image I_{F}, the vehicle-body rear-side image I_{B}, the vehicle-body left-side image I_{L}, and the vehicle-body right-side image I_{R} onto the 3D panoramic model 21 overlap each other. Therefore, the three-dimensional panoramic projection image Iₛᵤᵣᵣ may present a 3D around-view image around the vehicle 2. That is, the three-dimensional panoramic projection image further provides three-dimensional perception to realistically present the surrounding environment of the vehicle, so as to enable a driver to easily and intuitively recognize a height difference of a nearby object and a distance from the nearby object. In an embodiment, the three-dimensional panoramic projection image Iₛᵤᵣᵣ may include a virtual vehicle body Vc, to enable the driver to further easily determine an image around the vehicle 2 and a relative relationship of the vehicle 2.

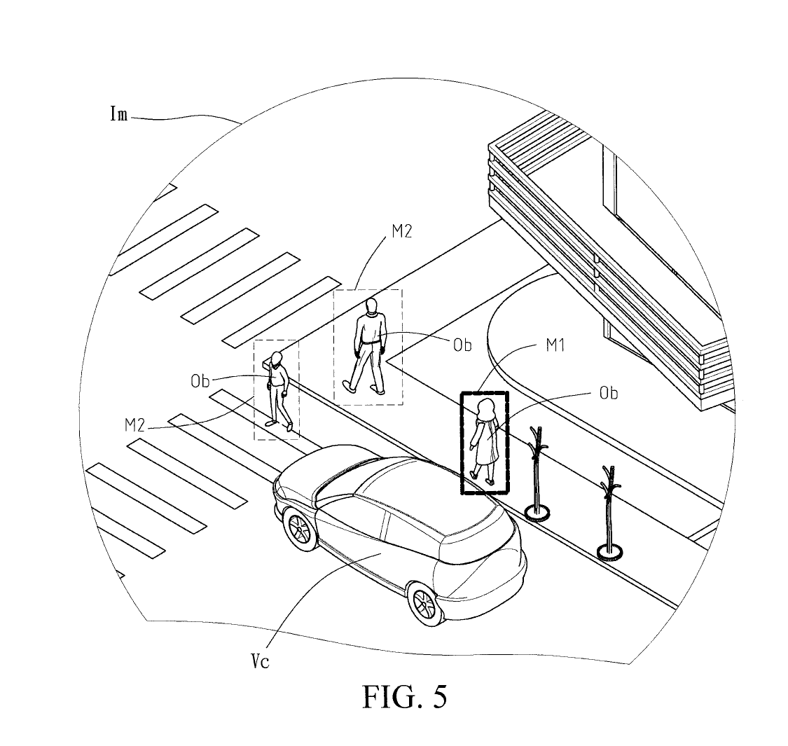

In an embodiment, the image processing module 30 is electrically connected to the three-dimensional image synthesis module 20, and the image processing module 30 receives the three-dimensional panoramic projection image Iₛᵤᵣᵣ. The image processing module 30 includes an obstacle recognition unit 31 and a labeling unit 32. In some embodiments, the image processing module 30, the obstacle recognition unit 31, and the labeling unit 32 may be specifically implemented by using a microcomputer, a processor or a dedicated chip. The obstacle recognition unit 31 may detect an obstacle Ob (for example, a pedestrian, a street tree or another vehicle) in the three-dimensional panoramic projection image Iₛᵤᵣᵣ. In an embodiment, the obstacle recognition unit 31 may determine whether it is the obstacle Ob by using the object in the three-dimensional panoramic projection image Iₛᵤᵣᵣ and a relative speed of the vehicle 2. The labeling unit 32 then sets a recognition label M1 for an image corresponding to the obstacle Ob to form a three-dimensional label image Iₘ. That is, in the three-dimensional label image Iₘ, in addition to the 3D around-view image around the vehicle 2, the recognition label M1 may further be displayed at the position of the obstacle Ob. In some embodiments, the recognition label M1 may be a pattern, a symbol or a text, and may have different display manners. For example, the recognition label M1 is presented in a flickering or shining manner. As shown in FIG. 5, in an embodiment, in the three-dimensional label image Iₘ, a 3D virtual vehicle body Vc representing the vehicle 2, the 3D around-view image around the vehicle 2, and the recognition label M1 are displayed. Here, the recognition label M1 is a box surrounding each obstacle Ob, thereby achieving an effect of prompting a driver. Therefore, the driver may instantly recognize the position of the obstacle Ob and a distance between the obstacle Ob and the vehicle 2, so that the driver can instantly react correspondingly (for example, hit the brake or avoid approaching the obstacle Ob).

In an embodiment, the obstacle recognition unit 31 further detects the distance between the obstacle Ob and the vehicle 2. The labeling unit 32 further sets different recognition labels M1 and M2 corresponding to obstacles Ob at different distances. For example, two obstacles Ob that are at different distances from the vehicle 2, the set recognition labels M1 and M2 may be separately different patterns, symbols, texts, colors, sizes, bold or thin lines or display manners, so that the driver can further determine the distances from the obstacles Ob according to the recognition labels. As shown in FIG. 5, in an embodiment, in the three-dimensional label image Iₘ, a recognition label M1 set for an obstacle Ob closer to the vehicle 2 is a relatively thick line, and a recognition label M2 set for an obstacle Ob farther away from the vehicle 2 is a relatively thin line. Therefore, the driver can further determine the distances from the obstacles Ob according to the recognition labels M1 and M2 in different forms. However, the present invention is not limited thereto. The recognition label M1 and the recognition label M2 may be distinguished by using other different manners. For example, the recognition label M1 is displayed to be red, and the recognition label M2 is displayed to be blue. Alternatively, the recognition label M1 is displayed to be a box, and the recognition label M2 is displayed to be a circle. Further alternatively, the recognition label M1 is presented in a flicker form, and the recognition label M2 is presented in a non-flickering form. It should be noted here that these simple changes in implementation forms should all fall within the scope of the technical features of the present invention.

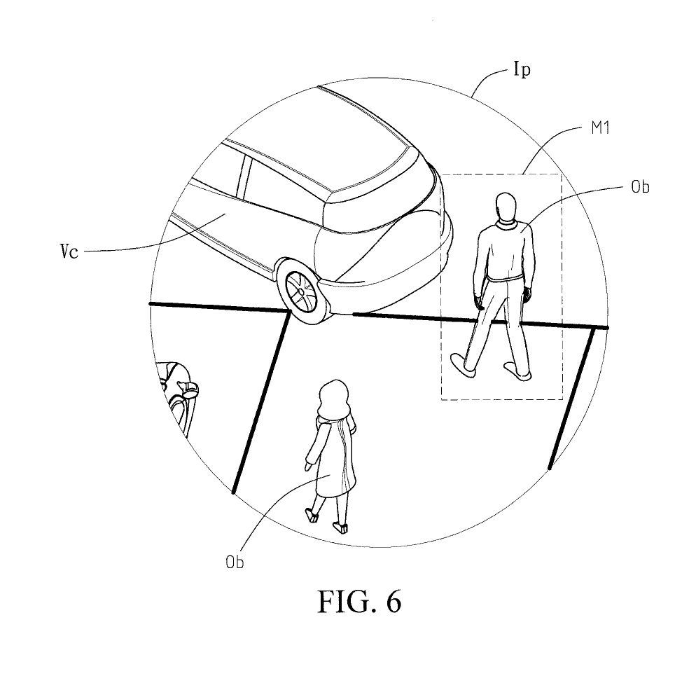

In an embodiment, the labeling unit 32 may set the recognition label M1 for the obstacle Ob only when the distance that is between the obstacle Ob and the vehicle 2 and is detected by the obstacle recognition unit 31 is less than a threshold value. For example, the labeling unit 32 sets the recognition label M1 only when the distance between the obstacle Ob and the vehicle 2 is less than 30 cm. For this, reference may further be made to FIG. 6. The recognition label M1 is set for only the obstacle Ob that is relatively close to the vehicle 2.

In some embodiments, the distance (for example, 30 cm or 50 cm) that is between the obstacle Ob and the vehicle 2 and is detected by the obstacle recognition unit 31 may also be directly displayed on the three-dimensional label image Iₘ.

The image processing module 30 selectively outputs the three-dimensional label image Iₘ. In some embodiments, the image processing module 30 outputs the three-dimensional label image Iₘ provided that there is an obstacle Ob near the vehicle 2. Alternatively, the image processing module 30 outputs the three-dimensional label image Iₘ according to a specific signal or a specific message. This is described in detail as follows:

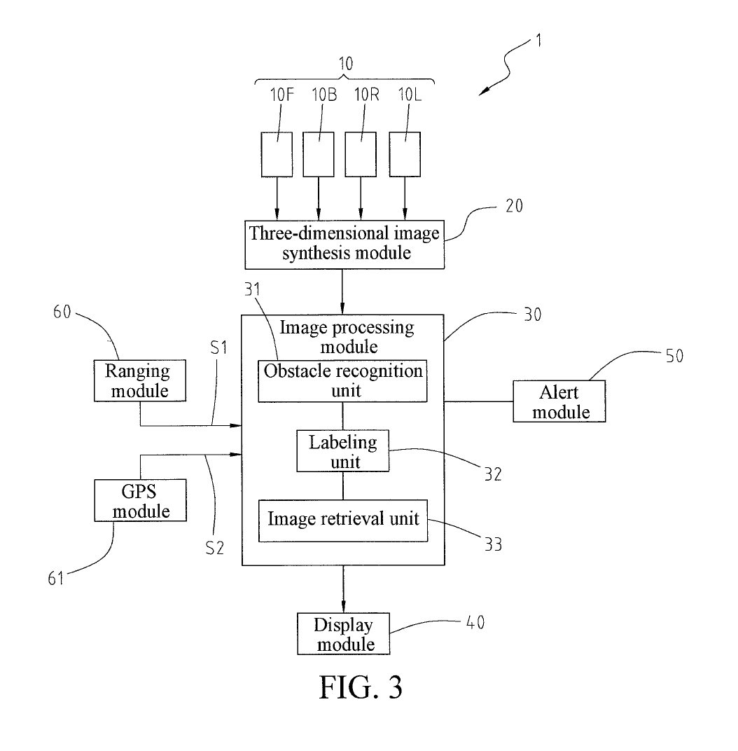

As shown in FIG. 3, in an embodiment, the three-dimensional driving image reminder device 1 further includes a ranging module 60. The ranging module 60 is electrically connected to the image processing module 30. The ranging module 60 outputs a proximity signal S1 according to the approach of the obstacle Ob. The image processing module 30 outputs the three-dimensional label image Iₘ corresponding to the proximity signal S1. That is, the image processing module 30 outputs the three-dimensional label image Iₘ only when the obstacle Ob moves towards the vehicle 2. In some embodiments, the ranging module 60 may be specifically a radar disposed around the vehicle 2, so as to detect whether the obstacle Ob is approaching. In some embodiments, the ranging module 60 may be electrically connected to the lens group 10 or the three-dimensional image synthesis module 20, so as to determine whether the obstacle Ob is approaching according to the external images or the three-dimensional panoramic projection image Iₛᵤᵣᵣ. The ranging module 60 may be specifically implemented by using a microcomputer, a processor or a dedicated chip.

As shown in FIG. 3, in an embodiment, the three-dimensional driving image reminder device 1 includes a GPS module 61, electrically connected to the image processing module 30. The GPS module 61 is disposed at the vehicle 2 and detects and outputs vehicle position information S2 (for example, the vehicle 2 travels at a crossing or in an alley). The image processing module 30 receives and selects, corresponding to the vehicle position information S2, whether to output the three-dimensional label image Iₘ. In some embodiments, the image processing module 30 may output the three-dimensional label image Iₘ when the vehicle position information S2 shows that the vehicle 2 is traveling in an alley, to alert the driver.

In an embodiment, the image processing module 30 outputs the three-dimensional label image Iₘ corresponding to a turn signal. That is, the image processing module 30 outputs the three-dimensional label image Iₘ when the driver a turn-signal light, to raise an alert.

As shown in FIG. 3, in an embodiment, the three-dimensional driving image reminder device 1 includes an alert module 50. The alert module 50 is electrically connected to the image processing module 30. The alert module 50 sends an alert message corresponding to the output of the three-dimensional label image Iₘ, to warn the driver about a nearby obstacle Ob, to prompt the driver to observe the three-dimensional label image Iₘ to avoid an accident. In some embodiments, the alert module 50 may be a buzzer, a voice module or an alert lamp, so as to alert the driver by sending an alert message of sound or light.

As shown in FIG. 3, in an embodiment, the image processing module 30 further includes an image retrieval unit 33. The image retrieval unit 33 receives the three-dimensional label image Iₘ and retrieves a part of the three-dimensional label image Iₘ to generate a partial label image I_{P}. The partial label image I_{P} includes the obstacle Ob and the recognition label M1. That is, a part with the obstacle Ob and the recognition label M1 in the three-dimensional label image Iₘ is partially enlarged for display in the partial label image I_{P}, so that the driver can further clearly recognize the obstacle Ob. The image processing module 30 selectively outputs the three-dimensional label image Iₘ or the partial label image I_{P} to the display module 40 for display. The alert module 50 sends the alert message corresponding to the output of the three-dimensional label image Iₘ or the partial label image I_{P}. For this, as shown in FIG. 6, in an embodiment, when the driver is reversing the vehicle 2 (for example, is parking the vehicle 2), the image processing module 30 may output a partially enlarged image (that is, the partial label image I_{P}) behind the vehicle 2, so that the driver can further clearly recognize an obstacle Ob behind the vehicle 2 to avoid an accident.

In addition, the lens group 10, the three-dimensional image synthesis module 20, the image processing module 30, the display module 40, the alert module 50, the ranging module 60, and the GPS module 61 may transmit data to each other by using a wired (for example, controller area network) or wireless (for example, WiFi, Bluetooth or ZigBee) manner. The present invention is not limited thereto. In addition, in some embodiments, the three-dimensional image synthesis module 20 and the image processing module 30 may be integrated in an internal circuit board of an on-board unit (OBU) mounted in the vehicle 2.

In conclusion, by means of image processing and synthesis, the three-dimensional driving image reminder device in the embodiments of the present invention first establishes a three-dimensional panoramic projection image, and then detects a position of an obstacle in the three-dimensional panoramic projection image, and correspondingly sets a recognition label, to output a three-dimensional label image to a display module for display, and an alert module correspondingly sends an alert message. Therefore, a displayed three-dimensional label image provides 3D perception to realistically present the surrounding environment of a vehicle, so as to enable a driver to easily and intuitively recognize a height difference of a nearby object and a distance from the nearby object. Furthermore, the alert message may warn a driver about a potential danger nearby, and the driver can instantly know the position of the obstacle and a distance between the obstacle and the vehicle according to the recognition label, so that the driver can instantly react correspondingly, thereby effectively improving the driving safety.

What is claimed is:

1. A three-dimensional driving image reminder device, applicable to a vehicle, and the three-dimensional driving image reminder device comprising:
a lens group, comprising a plurality of lenses, respectively disposed on different positions around the vehicle, and the lenses respectively photographing a plurality of external images around the vehicle and outputting the external images;
a three-dimensional image synthesis module, electrically connected to the lens group, the three-dimensional image synthesis module receiving the external images, synthesizing the external images into a three-dimensional panoramic projection image, and outputting the three-dimensional panoramic projection image;
an image processing module, electrically connected to the three-dimensional image synthesis module, and receiving the three-dimensional panoramic projection image, wherein the image processing module comprises an obstacle recognition unit and a labeling unit, the obstacle recognition unit detects an obstacle in the three-dimensional panoramic projection image, the labeling unit sets a recognition label corresponding to a position of the obstacle to form a three-dimensional label image, and the image processing module selectively outputs the three-dimensional label image; and
a display module, disposed in the vehicle and electrically connected to the image processing module, and the display module receiving and displaying the three-dimensional label image.

2. The three-dimensional driving image reminder device according to claim 1, wherein the recognition label is a pattern, a symbol or a text.

3. The three-dimensional driving image reminder device according to claim 1, wherein the obstacle recognition unit further detects a distance between the obstacle and the vehicle, and the labeling unit further sets different recognition labels corresponding to different distances.

4. The three-dimensional driving image reminder device according to claim 1, further comprising a ranging module, electrically connected to the image processing module, wherein the ranging module outputs a proximity signal according to the approach of the obstacle, and the image processing module outputs the three-dimensional label image corresponding to the proximity signal.

5. The three-dimensional driving image reminder device according to claim 1, further comprising a GPS module, electrically connected to the image processing module, wherein the GPS module is disposed at the vehicle and detects and outputs vehicle position information, and the image processing module receives and selectively outputs the three-dimensional label image corresponding to the vehicle position information.

6. The three-dimensional driving image reminder device according to claim 1, wherein the obstacle recognition unit further detects a distance between the obstacle and the vehicle, and the labeling unit sets the recognition label when the distance is less than a threshold value.

7. The three-dimensional driving image reminder device according to claim 1, wherein the image processing module outputs the three-dimensional label image corresponding to a turn signal.

8. The three-dimensional driving image reminder device according to claim 1, further comprising an alert module, electrically connected to the image processing module, wherein the alert module sends an alert message corresponding to an output of the three-dimensional label image.

9. The three-dimensional driving image reminder device according to claim 8, wherein the image processing module further comprises an image retrieval unit, the image retrieval unit receives the three-dimensional label image and retrieves a part of the three-dimensional label image to generate a the partial label image, the partial label image comprises the obstacle and the recognition label, the image processing module selectively outputs the three-dimensional label image or the partial label image to the display module, and the alert module sends the alert message corresponding to the output of the three-dimensional label image or the partial label image.

10. The three-dimensional driving image reminder device according to claim 8, wherein the alert module is a buzzer, a voice module or an alert lamp.

11. The three-dimensional driving image reminder device according to claim 1, wherein the lens group comprises:
a left-view lens, mounted on a left side of the vehicle, and the left-view lens photographing and outputting a vehicle-body left-side image;
a right-view lens, mounted on a right side of the vehicle, and the right-view lens photographing and outputting a vehicle-body right-side image;
a rear-view lens, mounted on a rear side of the vehicle, and the rear-view lens photographing and outputting a vehicle-body rear-side image, wherein the vehicle-body rear-side image and the vehicle-body left-side image at least partially overlap, and the vehicle-body rear-side image and the vehicle-body right-side image at least partially overlap; and
a front-view lens, mounted on a front side of the vehicle, and the front-view lens photographing and outputting a vehicle-body front-side image, wherein the vehicle-body front-side image and the vehicle-body left-side image at least partially overlap, and the vehicle-body front-side image and the vehicle-body right-side image at least partially overlap.
